(19) United States
(12) Patent Application Publication
(10) Pub. No.: US 2009/0071076 A1
(43) Pub. Date: Mar. 19, 2009

(54) SEALING PROFILE

(75) Inventors: Thorsten Ludtke, Mainz (DE); Robert Mann, Nierstein (DE)

Correspondence Address: INGRASSIA FISHER & LORENZ, P.C. (GME), 7010 E. COCHISE ROAD, SCOTTSDALE, AZ, 85253, US

(73) Assignee: Gm Global technology operations Inc., Detroit, MI (US)

(21) Appl. No.: 12/299,769

(22) PCT Filed: May 4, 2007
(86) PCT No.: PCT/EP2007/003956

§ 371 Date: Nov. 5, 2008

(30) Foreign Application Priority Data
May 6, 2006 (DE) 102006021190.1

(51) Int. Cl. B60J 10/04

(52) U.S. Cl. 49/483.1

(57) ABSTRACT

A sealing profile for the sealing of a mobile window pane of a motor vehicle door is provided with an elastic base that includes, but is not limited to a decorative panel area which can be positioned so as to face the motor vehicle exterior; this includes, but is not limited to a material recess in the decorative panel area and configured slot above and/or below the material recess for the mounting of a decorative panel in a clamping fit.

### CROSS-REFERENCE TO RELATED APPLICATIONS

This application is a U.S. National-Stage entry under 35 U.S.C. § 371 based on International Application No. PCT/EP2007/003956, filed May 4, 2007, which was published under PCT Article 21(2) and which claims priority to German Application No. 102006021190.1, filed May 6, 2006, which are all hereby incorporated in their entirety by reference.

### TECHNICAL FIELD

The invention relates to a sealing profile for sealing a mobile windowpane of a motor vehicle door; for example, the door of a passenger car.

### BACKGROUND

DE 102 47 015 A1 describes a sealing profile that has a decorative strip. In order to fasten the decorative strip to the base of the sealing profile, the decorative strip has a fastening element which extends horizontally into the base. The fastening element is configured as a long insertion limb. The insertion limb operates by trunnion-like rudiments, which secure a permanent, positive connection between the decorative strip and the sealing profile.

DE 199 22 749 A1 describes a seal for a windowpane. With the aid of special retaining clips, the decorative strip is fastened to the seal.

It is at least one object of an embodiment of the invention to supply a sealing profile of the above-described type, which makes the mounting of the decorative strip after the sheeting of the sealing profile on the motor vehicle possible. In addition, other objects, desirable features, and characteristics will become apparent from the subsequent summary and detailed description, and the appended claims, taken in conjunction with the accompanying drawings and this background.

### SUMMARY

This at least one object, other objects, desirable features, and characteristics are solved through a sealing profile for the sealing of a mobile windowpane of a motor vehicle door in accordance with embodiments of the invention.

An initial embodiment of the invention relates to a sealing profile for the sealing of a mobile windowpane of a motor vehicle door, the sealing profile having an elastic base. The base comprises a decorative panel that can be positioned to face the motor vehicle exterior. In the decorative panel, the base has a recess and at least one configured slot for mounting the decorative strip in a clamping fit beneath and/or above the recess.

The above-mentioned embodiment makes possible the mounting of a decorative strip even after the sheeting of the sealing profile on the motor vehicle. In this way, the window can, along with the sealing, be built into the window opening and the decorative strip can be mounted in a later process. The sheeting of the sealing profile and the mounting of the decorative strip thereby do not constitute a single operative step; this allows for more flexibility in the completion of the motor vehicle and gives more options for optimizing the process.

Further, the division of what was originally one operative step into two separate operative steps allows costs to be more precisely estimated; this ensures that the cost of a basic motor vehicle without a decorative strip and the cost of a motor vehicle with a decorative strip can be given. This makes it easier for the manufacturer to offer a wider spectrum of choice in the features of the motor vehicle and gives the customer a more varied selection.

In the subsequent mounting, a part of the decorative strip, for example the flange, is pressed into at least one of the slots accessible from the outside of the motor vehicle and remains in a clamping fit. Decorative strips with two flanges can be selected; in this case, two slots will be employed. The simultaneous enabling of a subsequent mounting of the decorative strip in combination with its long-lasting presence in or on the elastic base is achieved through a (material) recess of the base in the decorative panel area. The two walls of the slot are partially decoupled mechanically or elastically with the material recess so that the wall facing the material recess can be deformed and the other wall cannot. With the shape and size of the material recess, the extent to which the slot can be widened during the introduction of the decorative strip can be set according to the fact that the material of the base is pushed back in the direction of the material recess. At the same time, the clamping strength on said part of the decorative strip is set through the material recess. Through the mounting of the decorative strip in the clamping fit, it is permanently and securely mounted; in this way, the decorative strip can later be removed without damaging the base or the decorative strip.

In further embodiments, a cavity or a pocket hole is provided as a material recess. The concrete selection can be based on how the base and its material recess are manufactured.

An embodiment of the sealing profile provides horizontally aligned slots. As a result, the corresponding decorative strip is undercut, which additionally secures it in a horizontal direction.

In a further embodiment of the sealing profile, the slot has a socket on the end in which an allocated extension or thickening of the decorative strip can positively extend. The clamping fit of the decorative strip is completed in this way through a positive connection between the decorative strip and the base. In this case, removing the decorative strip without damaging the base and the decorative strip is also possible because the socket and the slot are capable of widening enough when the thickened decorative strip area is pulled out.

A variation of the sealing profile further provides a stiffening element. The stiffening element allows the sealing profile to have a better mechanical mounting to the car body. A metallic profile, for example a U-shaped profile, can be used as a stiffening element. In general, the metallic profile is adjusted to the geometry of the fastening area in relation to its own geometry.

An embodiment of the sealing profile further provides the mechanical or elastic decoupling of the slot from the fastening area of the sealing profile on the motor vehicle and/or from the area of the stiffening element. In the case of an elastic decoupling of two areas, it is understood that an elastic deformation of the first area is independent from an elastic deformation of the second area. For example, if in the first area a deformation is not possible because of the presence of rigid elements, this has no influence, in the case of an elastic decoupling, on the malleability of the second area. This, in relation to the sealing profile, means that an elastic deformation of the sealing profile material in the area of the slot is independent from the deformation of the sealing profile material in the area of the stiffening element and/or a deformation of the sealing profile in the fastening area. The stiffening element is configured rigidly and the fastening of the sealing element on the car body is made from a rigid element (in the first case, the stiffening element is, for example, configured as a rigid U-shape and in the second case, the fastening ensues, for example, with a metal flange); for this reason, the configuration demands that the sealing profile of the decorative strip mounting is malleable and can be pushed back in the direction of the recess in the decorative strip area. In this way, the decorative strip mounting is simplified in that no rigid sealing profile or car body parts make the deformation of the sealing profile material difficult. This simplification of the process applies particularly in the case where a mounting of the decorative strip occurs later; that is, mounting occurs after the mounting of the sealing profile in two separate steps, as described above.

The elastic decoupling can be achieved in that the named areas are distanced far enough away from each other. Alternatively and/or cumulatively, the decoupling can also be achieved through the selection of a sealing profile from materials with varying elasticity. For example, the sealing profile material can be more elastic in the area of the stiffening element and/or in the fastening area than in the slot area, namely in the section facing the decorative strip.

A further embodiment provides a sealing profile with a stiffening element that encircles the stiffening element of the motor vehicle sealing profile's fastening area at least in the part facing the decorative strip area; the slot area is elastically decoupled from the area of the stiffening element. This configuration also simplifies the mounting of decorative strip.

Further embodiments of the sealing profile are completed with decorative strip mounted above the slot. The decorative strip can be an aluminum extrusion press section or a rolled section of premium steel, and in the latter case the rolled or roll-formed premium steel section can be stretch-bent into its final form. In the choice of premium steel, one should make sure that it is a non-corrosive, reasonably priced material which is available world-wide and with a wide delivery range; this makes possible the use of a uniform material for decorative strips by automobile companies which operate world-wide. In addition, it makes possible the use of a smaller number of components, which, in turn, lowers costs. Premium steel is also available in many shades, ensuring additional design options.

### BRIEF DESCRIPTION OF THE DRAWINGS

The present invention will hereinafter be described in conjunction with the following drawing figures, wherein like numerals denote like elements, and

FIG. 1 a schematic side view of a motor vehicle with a sealing in accordance with an embodiment;

FIG. 2 a section along the length A-A in FIG. 1 in an initial embodiment;

FIG. 3 a section along the length A-A in FIG. 1 in a second embodiment; and

FIG. 4: a section along the length A-A in FIG. 1 in a third embodiment.

### DETAILED DESCRIPTION

The following detailed description is merely exemplary in nature and is not intended to limit application and uses. Furthermore, there is no intention to be bound by any theory presented in the preceding summary and background or the following detailed description.

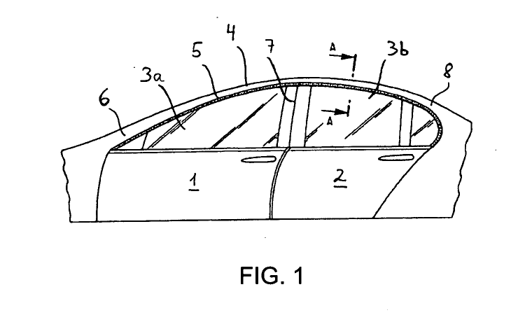

FIG. 1 shows a side view of a motor vehicle which has a front door 1 and a back door 2; each of these has a vertically mobile window pane 3a, 3b. The window panes 3a, 3b can be lowered into a window well in front door 1 or back door 2 (this window well is not shown in FIG. 1); these are sealed facing above and opposite the car body 4 with a sealing profile 5 which will be explained in the following with the aid of the other figures. The sealing profile 5 stretches from the lower closure of the A-column 6 over the B-column 7 to the lower closure of the C-column 8.

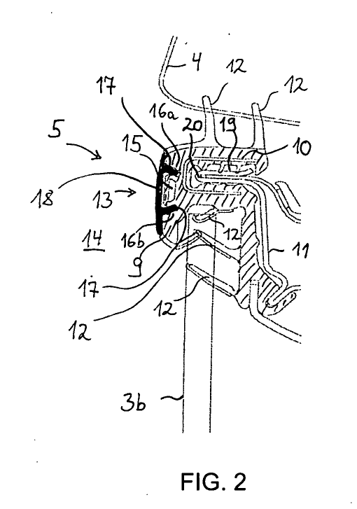

FIG. 2 displays a section of the line A-A in FIG. 1. The sealing profile 5 has a rubber-elastic base 9, which provides a stiffening element 10 and is fastened to a door flange 11 and seals the windowpane 3b to the car body 4 with the use of sealing lips 12.

The base 9 has a material recess 15 in the decorative panel area 13 facing the motor vehicle exterior 14. Above and below the material recess which has been configured as a cavity, a slot 16a, 16b is located. In the slots 16a, 16b, flanges 17 of the decorative strip 18 are located. The decorative strip 18 is made out of extrusion pressed aluminum and rests in a clamp fit in the base 9. The shape and size of the material recess 15 are selected in such a way that the decorative strip 18 is securely clamped in the slots 16a, 16b. A secure clamping is supported in that the slots 16a, 16b are configured diagonal to the horizontal ones, thereby forming an undercut.

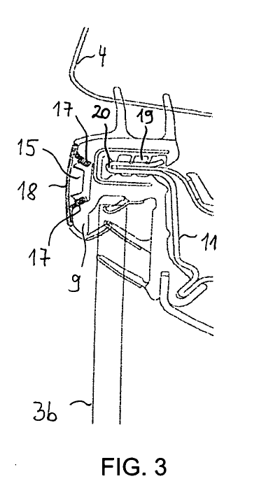

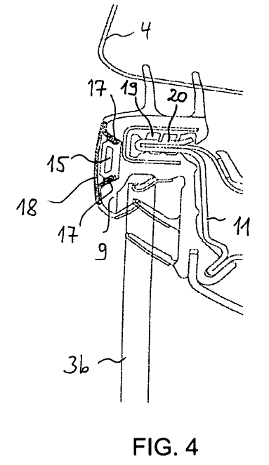

In contrast to FIG. 2, in the FIG. 3, and FIG. 4 the decorative strip 18 is configured as a rolled premium steel section with beaded flanges 17. In FIG. 3, the material recess 15 is a pocket hole and in FIG. 4 it is a cavity.

In the displayed embodiments, the fastening area 19, that is the area for the fastening of the sealing profile 5 to the horizontal section 20 of the door flange 11, is encircled by a stiffening element 10 with a U-shaped profile. The stiffening element 10 is separated away from the area of the slots 16a, 16b or is spaced apart from the fastening area 19 in the direction of the surface of the decorative strip 13. The spatial separation or the above-mentioned space is selected to be big enough for both areas to be elastically decoupled despite being immediately next to one another. This is not strictly necessary for the sealing profile 5, but simplifies the pushing back of the sealing profile material in the direction of the recess 15 during the mounting of the decorative strip because the material deformation is not hindered by the stiffening element 10. This applies particularly when the sealing profile is mounted on the car body in a first operative step and the decorative strip is subsequently fastened in a second operative step.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A sealing profile for the sealing of a window pane of a door of a motor vehicle with an elastic base comprising:
a decorative panel area positioned so as to face an exterior of the motor vehicle;
a material recess the decorative panel area; and
plurality of slots in at least one of above/or below the material recess for mounting of a decorative panel in a clamping fit.

2. The sealing profile according to claim 1, where the material in which the recess is a cavity.

3. The sealing profile according to claim 1. wherein the material recess is a pocket hole.

4. The sealing profile according to claim 1, wherein the plurality of slots are configured diagonal to a horizontal.

5. The sealing profile according to claim 1, wherein the plurality of slots have a socket at an end in which an extension of the decorative panel area can positively extend.

6. The sealing profile according to claim 1, further comprising a stiffening element.

7. The sealing profile according to claim 1, wherein the decorative panel area of the plurality of slots is elastically decoupled from a fastening area of the sealing profile.

8. The sealing profile according to claim 6, wherein the stiffening element encircles a fastening area of the sealing profile on the motor vehicle at least in a section facing the decorative panel area and in which the decorative panel area containing the plurality of slots is elastically decoupled from an area of the stiffening element.

9. The sealing profile according to claim 1, further comprising decorative panel mounted with the plurality of slots.

10. The sealing profile according to claim 9, wherein the decorative panel area is a rolled section of steel.
